(19) United States
(12) Patent Application Publication
(10) Pub. No.: US 2011/0038369 A1
(43) Pub. Date: Feb. 17, 2011

(54) COMMUNICATION METHOD AND APPARATUS BASED ON USER DATAGRAM PROTOCOL

(76) Inventors: Kwangil LEE, Daejeon (KR); Jun Hee PARK, Daejeon (KR); Won Suk CHOI, Daejeon (KR); Kyeong Deok MOON, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/566,893

(22) Filed: Sep. 25, 2009

(30) Foreign Application Priority Data
Aug. 14, 2009 (KR) 10-2009-0075021

(51) Int. Cl. H04L 12/56

(52) U.S. Cl. 370/389

(57) ABSTRACT

A communication method based on user datagram protocol (UDP) in a transmitter includes: segmenting a message provided thereto into packets of a predetermined size; allocating a serial number to each of the segmented packets; storing the segmented packets in a packet buffer to transmit the packets to a receiver in order of the allocated serial numbers; and waiting for a control message indicating packet receipt completion from the receiver. The communication method based on UDP in a receiver includes: receiving packets segmented by a predetermined size in order of serial numbers from a transmitter; and when the received segmented packets are message packets and there is no missing packet, assembling the segmented packets in order of the serial numbers to complete a message.

### CROSS-REFERENCE(S) TO RELATED APPLICATION(S)

The present invention claims priority of Korean Patent Application No. 10-2009-0075021, filed on Aug. 14, 2009, which is incorporated herein by reference.

### FIELD OF THE INVENTION

The present invention relates to a communication technology based on user datagram protocol (UDP), and, more particularly, relates to a communication method and apparatus suitable for reliably and effectively transmitting massive massages based on UDP.

### BACKGROUND OF THE INVENTION

An Internet-based communication service is provided based on transmission control protocol (TCP) which serves reliable communications, or user datagram protocol (UDP) which serves unreliable communications, on the basis of the internet protocol (IP).

TCP communication guarantees stable receipt of transmitted messages in a receiver by exchanging a variety of control messages to check the receipt status of the messages and by controlling transmission speed. However, TCP may have low efficiency due to exchange of a variety of control messages and has a disadvantage of only supporting one to one transmission for retransmission of the messages.

On the contrary, in UDP communication, since a transmitter may continuously transmit messages without considering whether a receiver is ready to receive the messages, UDP communication has good transmission efficiency. However, the transmitter does not check receipt status of messages in the receiver and also does not perform retransmission of messages depending on the check result of the message receipt status, so that UDP communication cannot guarantee reliability of the messages. Since the receiver does not need to keep received messages, such a UDP may be a communication service capable of multicasting or broadcasting.

Recently, a necessity of both efficiency in message transmission provided by UDP and reliability in message transmission provided by TCP has been raised.

In case of transmitting a message using TCP and UDP, since one packet cannot carry a large amount of information, a transmitter segments a message in each packet size and a receiver reassembles the segmented message in good order. Generally, a size of a message which one packet can carry is 64 Kbytes in TCP and UDP communication. Segmentation and reassembly (SAR) process of the message are performed in IP, so that if one packet (IP packet) is missing, the entire message needs to be retransmitted, thereby increasing network loads and reducing transmission efficiency. Therefore, an effective retransmission mechanism is required for an efficient and reliable transmission of messages.

### SUMMARY OF THE INVENTION

In view of the above, the present invention provides a communication method and apparatus based on user datagram protocol (UDP) using messages segmentation and reassembly (SAR) process and messages retransmission technique.

In accordance with a first aspect of the present invention, there is provided a communication method based on user datagram protocol (UDP) in a transmitter, including:

segmenting a message provided thereto into packets of a predetermined size;

allocating a serial number to each of the segmented packets;

storing the segmented packets in a packet buffer to transmit the packets to a receiver in order of the allocated serial numbers; and

waiting for a control message indicating packet receipt completion from the receiver.

In accordance with a second aspect of the present invention, there is provided a communication method based on user datagram protocol (UDP) in a receiver, including:

receiving packets segmented by a predetermined size in order of serial numbers from a transmitter; and

when the received segmented packets are message packets and there is no missing packet, assembling the segmented packets in order of the serial numbers to complete a message.

In accordance with a third aspect of the present invention, there is provided a transmitter in a communication apparatus based on user datagram protocol (UDP), including:

a message receipt unit for receiving a message provided thereto;

a message segmentation unit for segmenting the message provided from the message receipt unit into packets of predetermined size;

a packet buffer for storing the packets segmented by the message segmentation unit;

a packet transmission unit for transmitting the segmented packets stored in the packet buffer as a single UDP datagram;

a control packet generation unit for generating a control packet for checking receipt status of the message in receiver when any of the segmented packets is missing;

an event processing unit for processing timer set-up and time-out event; and

a control packet processing unit for requiring the control packet generation unit to generate a control packet when receiving a response control packet from the receiver.

In accordance with a fourth aspect of the present invention, there is provided a receiver in a communication apparatus based on user datagram protocol (UDP), including:

a packet receipt unit for receiving packets segmented by a predetermined size from a transmitter;

a message packet processing unit for checking status of the segmented packets provided from the packet receipt unit;

a control packet processing unit for processing the segmented packets provided from the packet receipt unit when the segmented packets are control packets and transmitting a response control packet to the transmitter if necessary; and

a packet assembly unit for assembling the segmented packets delivered from the message packet processing unit in order of serial numbers of the segmented packets to complete a message.

### BRIEF DESCRIPTION OF THE DRAWINGS

The above features of the present invention will become apparent from the following description of embodiments given in conjunction with the accompanying drawings, in which:

FIG. 1 shows a block diagram of communication apparatus based on UDP in accordance with an embodiment of the present invention.

FIG. 2 shows a flowchart illustrating a communication process in a transmitter in UDP-based communication in accordance with the embodiment of the present invention.

FIG. 3 describes a message header for transmitting a message used in the embodiment of the present invention.

FIG. 4 shows a flowchart illustrating a communication process in a receiver in UDP-based communication in accordance with the embodiment of the present invention.

FIG. 5 is a flowchart showing a communication process when message loss is detected by time-out event.

### DETAILED DESCRIPTION OF THE EMBODIMENTS

Hereinafter, embodiments of the present invention will be described in detail with reference to the accompanying drawings.

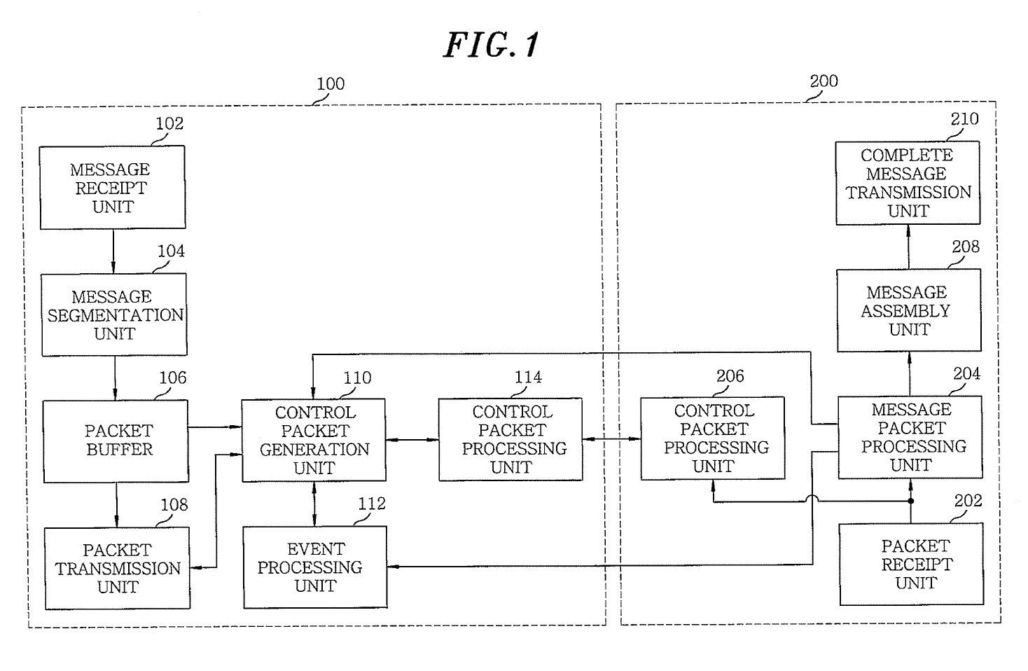

FIG. 1 shows a block diagram of a communication apparatus based on user datagram protocol (UDP) in accordance with an embodiment of the present invention. The apparatus includes a transmitter 100 and a receiver 200.

The transmitter 100 includes a message receipt unit 102, a message segmentation unit 104, a packet buffer 106, a packet transmission unit 108, a control packet generation unit 110, an event processing unit 112, and a control packet processing unit 114.

The message receipt unit 102 receives one or more messages from an application service to provide them to the message segmentation unit 104. The message segmentation unit 104 segments the received messages into packets, for example, single UDP packets, and allocates serial numbers to the packets. The packet buffer 106 stores the segmented packets so as to transmit or retransmit the segmented packets. The packet transmission unit 108 transmits the segmented packets stored in the packet buffer 106 as a UDP datagram. The control packet generation unit 110 generates a control packet when a loss of the packets has occurred to check the receipt status of the message in receiver 200. The event processing unit 112 performs processing of events such as timer setup or time-out. The control packet processing unit 114 requires the control packet generation unit 110 to generate a control packet in case of receiving a respond control packet from the receiver 200.

The receiver 200 includes a packet receipt unit 202, a message packet processing unit 204, a control packet processing unit 206, a packet assembly unit 208, and a complete message transmission unit 210.

The packet receipt unit 202 receives the packets, for example, single UDP packets from the transmitter 100 to provide the packets to both the message packet processing unit 204 and the control packet processing unit 206.

The message packet processing unit 204 checks the packets received from the packet receipt unit 202. Depending on the check result, the message packet processing unit 204 delivers the received packets to the packet assembly unit 208 or transmits a message which requires generation of a control packet for packet retransmission to the control packet generation unit 110 of the transmitter 100. Specifically, when it is determined that the packets provided from the packet receipt unit 202 are message packets and there is no loss of the packets, i.e., normally received packets, the message packet processing unit 204 delivers the packets to the packet assembly unit 208. If, however, it is determined that there is a loss of the packets, in other words, the packets have been abnormally received, the message packet processing unit 204 transmits the message which requires generation of a control packet for packet retransmission to the control packet generation unit 110 of the transmitter 100.

When the packets provided from the packet receipt unit 202 are control packets, the control packet processing unit 206 of the receiver 200 performs processing of the control packets. At this time, the control packet processing unit 206 may transmit a respond control packet to the control packet processing unit 114 of the transmitter 100 if necessary.

The packet assembly unit 208 assembles the packets provided from the message packet processing unit 204 in order of serial numbers of the packets to complete the message. The complete message transmission unit 210 receives the complete message from the packet assembly unit 208 to transmit the complete message to an application service.

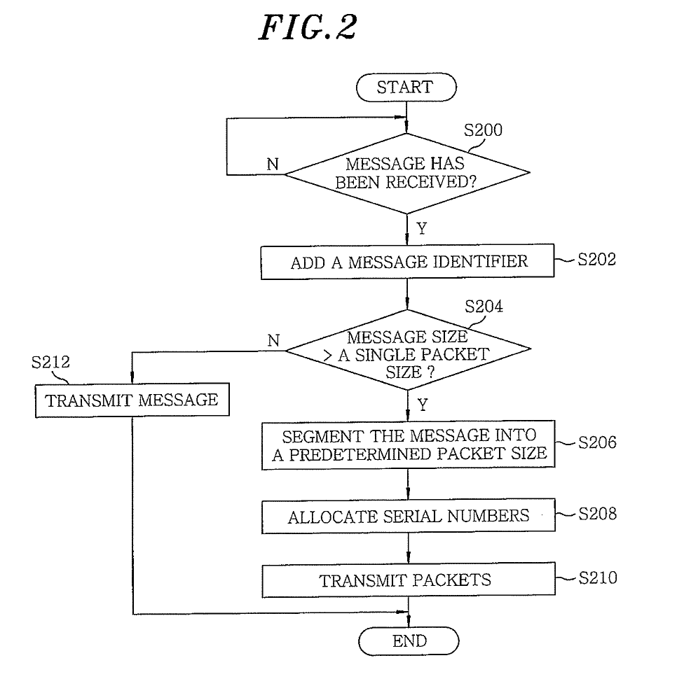

Hereinafter, a communication method based on UDP will be described in detail with reference to FIGS. 2 to 5 in accordance with the embodiment of the present invention.

FIG. 2 shows a flowchart illustrating a communication process in the transmitter 100 in UDP-based communication.

When a message from an application service is transmitted to the message receipt unit 102 of the transmitter 100 in step S200, the message receipt unit 102 adds both a service identifier and a message identifier to a header of the message in step S202 and delivers the message to the message segmentation unit 104.

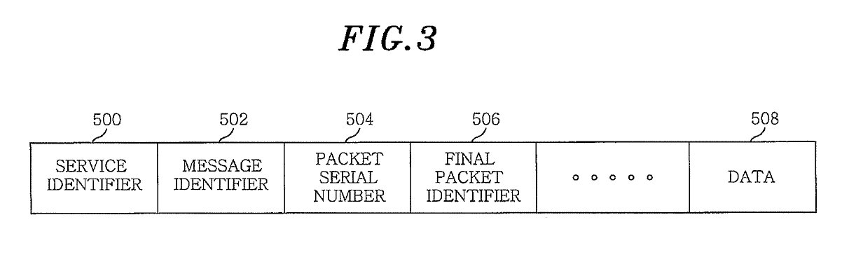

FIG. 3 shows a configuration of the message header. As shown in FIG. 3, the message header is composed of a service identifier 500, a message identifier 502, a packet serial number 504, a final packet identifier 506, and data 508. The service identifier 500 represents service characteristics of the corresponding application service and the message identifier 502 represents message characteristics of the corresponding message.

Referring to FIG. 2 again, if a size of the message delivered from the message receipt unit 102 is bigger than that of a single UDP packet (for example, 1500 bytes in case of Ethernet) or a predetermined size of UDP datagram in step S204, the message segmentation unit 104 segments the message into packets of a predetermined size in step S206 and allocates the packet serial numbers 504 to the message segmented into the packets, i.e., the segmented packets, respectively, in step S208. These packet serial numbers 504 are allocated only to packets which belong to the identical message identifier.

Next, in step S210, the segmented packets given the packet serial numbers 504 are stored in the packet buffer 106 and are then transmitted to the receiver 200 in order of the packet serial numbers 504 via the packet transmission unit 108.

If, in step S204, a size of the message delivered from the message receipt unit 102 is not bigger than that of a single UDP packet or a predetermined size of UDP datagram, the transmitter 100 transmits the message to the receiver 200 without performing the segmentation of the message in step S212.

The receiver 200 may recognize whether a transmitted packet is a final packet, using the final packet identifier 506 in the message header shown in FIG. 3. That is, the final packet identifier 506 may be a criterion to judge whether all of the packets which belong to the same message identifier are completely transmitted.

When all of the packets which belong to the same message identifier have been transmitted, the transmitter 100 waits for a control message indicating packet receipt completion from the receiver 200. If the transmitter 100 receives the control message indicating the packet receipt completion from the receiver 200, the transmitter 100 empties the packet buffer 106 and starts to transmit a subsequent message.

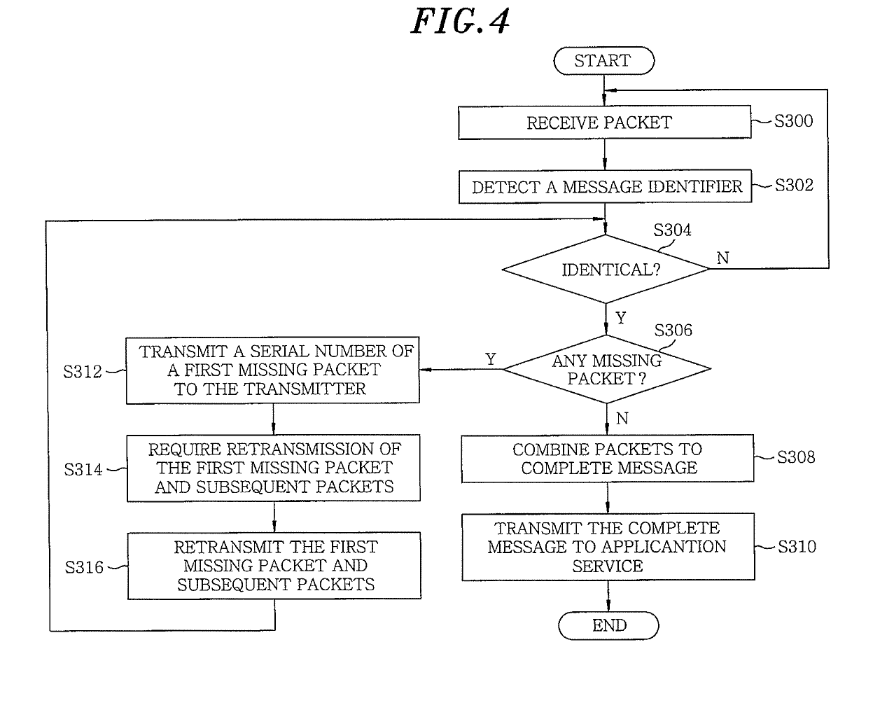

FIG. 4 shows a flowchart illustrating a communication process in the receiver 200 in UDP-based communication.

The packet receipt unit 202 of the receiver 200 receives a message segmented into packets of a predetermined size, i.e., segmented packets from the transmitter 100 in step S300. The segmented packets are delivered to the message packet processing unit 204. Then, the message packet processing unit 204 detects respective message identifiers from the segmented packets in step S302, and checks whether the respective message identifiers of the segmented packets are identical to each other in step S304.

Subsequently, in step S306, the message packet processing unit 204 determines whether the packets have arrived in numerical order without any missing packets by checking the packet serial numbers 504.

If the respective message identifiers of the segmented packets are identical to each other, and the segmented packets are arrived in order of the packet serial numbers 504, the message packet processing unit 204 sends the segmented packets to the packet assembly unit 208.

Thereafter, the packet assembly unit 208 assembles the segmented packets in order of the packet serial numbers to generate a complete message in step S308. At this time, the packet assembly unit 208 generates the complete message when having received all of the segmented packets which belong to the same message.

The complete message is provided to the complete message transmission unit 210, and the complete message transmission unit 210 transmits the complete message to the application service in step S310.

In the meantime, when having received a final packet of the segmented packets, the message packet processing unit 204 transmits a control message, which indicates that the receiver 200 has received all the segmented packets, to the transmitter 100 via the control packet generation unit 110.

Then, the transmitter 100 empties the packet buffer 106 and may start to transmit a new subsequent message.

Meanwhile, in step S306, if the message packet processing unit 204 of the receiver 200 determines that there is any missing packet by checking the packet serial numbers 504 of the segmented packets received from the packet receipt unit 202, the message packet processing unit 204, in step S312, transmits a serial number of a first missing packet to the transmitter 100 via the control packet generation unit 110. Also, the message packet processing unit 204 generates a control message requiring retransmission of the first missing packet and subsequent packets, and transmits the control message to the transmitter 100 via the control packet generation unit 110 in step S314.

Then, the transmitter 100 stops packet transmission currently being performed, and allows the packet buffer 106 of the transmitter 100 to retransmit the packets required by the message packet processing unit 204 of the receiver 200 in step S316.

Thereafter, the process returns to step S304, so that the transmitter 100 may transmit all packets which belong to the same message. After that, the transmitter 100 waits for receiving a control message which indicates that the receiver 200 has received all packets which belong to the same message.

It has been shown and described above that the receiver 200 can detect a loss of packets during packet transmission. And such detection may also be made in the transmitter 100.

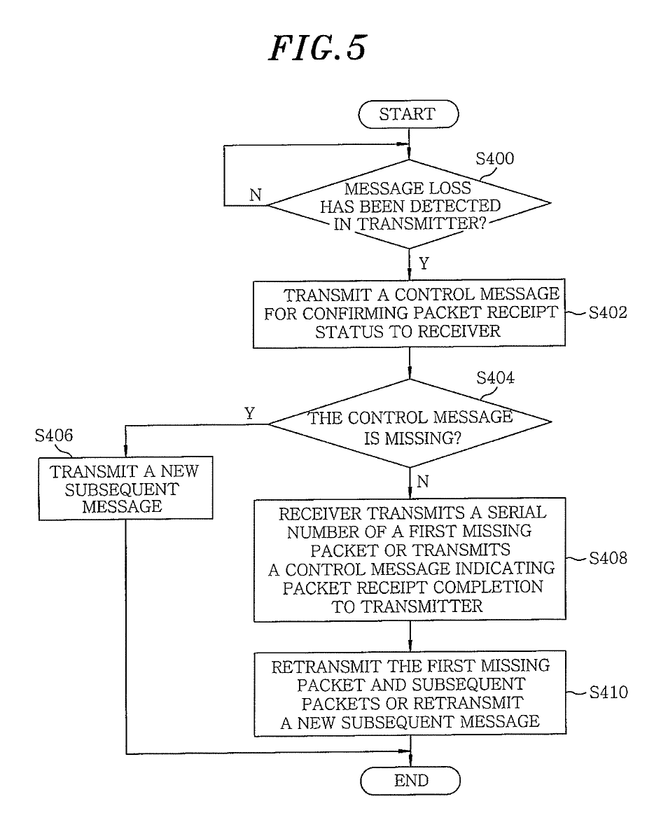

When a final packet is missing or a control message indicating packet receipt completion from the receiver 200 is missing, the transmitter 100 can detect a loss of the packets, by a time-out event set up after transmitting the final packet. A subsequent process will be described in detail with reference to FIG. 5.

Referring to FIG. 5, if the event processing unit 112 of the transmitter 100 detects a packet loss by a time-out event in step S400, the control packet generation unit 110 generates a control message for confirming packet receipt status of the receiver 200 and transmits the control message to the receiver 200 in step S402. At this time, if the control message from the control packet generation unit 110 is also missing in step S404, the event processing unit 112 processes the event as a time-out event. In this case, the transmitter 100 abandons retransmission of the control message or transmission of the current message to transmit a new message with a newly allocated message identifier in step S406.

However, if there is no loss of the control message transmitted from the control packet generation unit 110 in step S404, the receiver 200 normally receives the control message for confirming packet receipt status to confirm the status of the received packets. As a result of the confirmation, if missing packets exist, the receiver 200 transmits a serial number of a first missing packet, and if the receiver 200 has received all the packets without any missing packet, the receiver 200 transmits a control message indicating packet receipt completion to the transmitter 100 in step S408. Then, in step S410, when receiving the serial number of the first missing packet from the receiver 200, the transmitter 100 retransmits a packet of the received serial number, i.e., the first missing packet, together with packets of the subsequent serial numbers, or, when receiving the control message indicating packet receipt completion from the receiver 200, the transmitter 100 starts to transmit a new subsequent message.

When the receiver 200 receives a message identifier of a new message, the packet assembly unit 208 clears all buffers which have stored packets for packet combination and allocates the buffers for the new message so as to store new packets.

As described above, the present invention provides segmentation and reassembly (SAR) process for application service messages and provides a message retransmission method using exchange of control messages, thereby enabling an implementation of a simple, effective and reliable communication system.

While the invention has been shown and described with respect to the embodiments, it will be understood by those skilled in the art that various changes and modification may be made without departing from the scope of the invention as defined in the following claims.

What is claimed is:

1. A communication method based on user datagram protocol (UDP) in a transmitter, comprising:
segmenting a message provided thereto into packets of a predetermined size;
allocating a serial number to each of the segmented packets;
storing the segmented packets in a packet buffer to transmit the packets to a receiver in order of the allocated serial numbers; and
waiting for a control message indicating packet receipt completion from the receiver.

2. The communication method of claim 1, wherein said segmenting the message is performed when a size of the message is bigger than that of a single UDP packet or a predetermined size of UDP datagram.

3. The communication method of claim 1, wherein said waiting for the control message includes:
when the control message indicating packet receipt completion is received from the receiver, emptying the packet buffer and starting to transmit a new message;
when a control message requiring retransmission is received from the receiver, stopping the transmission of the packets to retransmit a packet of a required serial number by the receiver and packets of subsequent serial numbers from the packet buffer.

4. The communication method of claim 1, wherein said transmitting the packets includes adding a final packet identifier to the message so that the receiver recognizes whether the transmitted packet is a final packet or not.

5. The communication method of claim 1, the message includes a service identifier according to service characteristics of an application service.

6. The communication method of claim 1, wherein the serial numbers are allocated only to packets with an identical message identifier.

7. A communication method based on user datagram protocol (UDP) in a receiver, comprising:
receiving packets segmented by a predetermined size in order of serial numbers from a transmitter; and
when the received segmented packets are message packets and there is no missing packet, assembling the segmented packets in order of the serial numbers to complete a message.

8. The communication method of claim 7, further comprising:
transmitting a control message indicating packet receipt completion to the transmitter when a final one of the segmented packets is received;
transmitting a control message requiring packet retransmission to the transmitter if any missing packet exists by a check result of the serial numbers.

9. The communication method of claim 7, wherein said assembling the segmented packets includes:
determining whether message identifiers of the received segmented packets are identical to each other, and whether the segmented packets are transmitted in order of the serial numbers;
when message identifiers of the received segmented packets are identical to each other and the segmented packets are transmitted in order of the serial numbers, assembling the segmented packets in order of the serial numbers to produce the complete message.

10. The communication method of claim 7, the message includes a service identifier according to service characteristics of an application service.

11. The communication method of claim 7, wherein the serial numbers are allocated only to packets with an identical message identifier.

12. A transmitter in a communication apparatus based on user datagram protocol (UDP), comprising:
a message receipt unit for receiving a message provided thereto;
a message segmentation unit for segmenting the message provided from the message receipt unit into packets of predetermined size;
a packet buffer for storing the packets segmented by the message segmentation unit;
a packet transmission unit for transmitting the segmented packets stored in the packet buffer as a single UDP datagram;
a control packet generation unit for generating a control packet for checking receipt status of the message in receiver when any of the segmented packets is missing;
an event processing unit for processing timer set-up and time-out event; and
a control packet processing unit for requiring the control packet generation unit to generate a control packet when receiving a response control packet from the receiver.

13. The transmitter of claim 12, wherein the message segmentation unit allocates serial numbers to the segmented packets.

14. The transmitter of claim 12, wherein the control packet generation unit generates the control packet for checking receipt status of the message when any missing packet is detected by the time-out event of the event processing unit.

15. A receiver in a communication apparatus based on user datagram protocol (UDP), comprising:
a packet receipt unit for receiving packets segmented by a predetermined size from a transmitter;
a message packet processing unit for checking status of the segmented packets provided from the packet receipt unit;
a control packet processing unit for processing the segmented packets provided from the packet receipt unit when the segmented packets are control packets and transmitting a response control packet to the transmitter if necessary; and
a packet assembly unit for assembling the segmented packets delivered from the message packet processing unit in order of serial numbers of the segmented packets to complete a message.

16. The receiver of claim 15, wherein the message packet processing unit delivers the segmented packets provided from the packet receipt unit to the packet assembly unit, when it is checked that the segmented packets are message packets and there is no missing packet.

17. The receiver of claim 15, wherein the message packet processing unit transmits a message requiring generation of a control packet to the transmitter, when it is checked that the segmented packets provided from the packet receipt unit are message packets and there is any missing packet.

18. The receiver of claim 15, wherein the message packet processing unit determines whether any of the segmented packets is missing by checking the serial numbers, and, depending on the determination result, transmits a control message indicating packet receipt completion or a message requiring generation of a control packet to the transmitter.
